(19) United States
(12) Patent Application Publication
(10) Pub. No.: US 2018/0010675 A1
(43) Pub. Date: Jan. 11, 2018

(54) DAMPER OF TORQUE CONVERTER FOR VEHICLE

(71) Applicant: Hyundai Motor Company, Seoul (KR)

(72) Inventors: Jin Mo PARK, Gwacheon-si (KR); Kang Soo SEO, Yongin-si (KR); Young Seok SON, Seoul (KR); Ho Jin JI, Anyang-si (KR); Myoung Chul LEE, Bucheon-si (KR); Pan Seok WE, Hwaseong-si (KR)

(73) Assignee: Hyundai Motor Company, Seoul (KR)

(21) Appl. No.: 15/372,605

(22) Filed: Dec. 8, 2016

(30) Foreign Application Priority Data
Jul. 7, 2016 (KR) 10-2016-0085990

(51) Int. Cl. F16H 45/02; F16F 15/123

(52) U.S. Cl. CPC F16H 45/02; F16F 15/12353; F16H 2045/0221

(57) ABSTRACT

A damper of a torque converter for a vehicle may include a front cover, an impeller rotatably coupled to the front cover, a turbine disposed facing the impeller, a reactor disposed between the impeller and the turbine for changing flow of oil transferred from the turbine toward the impeller, a driving disk assembled to a driving hub connected to the front cover, a driven hub to which a driven disk is assembled, a turbine shell connected to a turbine hub transferring torque to a transmission, and a driven plate connected to the turbine shell.

### CROSS-REFERENCE TO RELATED APPLICATION

The present application claims priority to Korean Patent Application No. 10-2016-0085990, filed Jul. 7, 2016, the entire contents of which is incorporated herein for all purposes by this reference.

### BACKGROUND OF THE INVENTION

### Field of the Invention

The present invention relates to a damper of a torque converter for a vehicle, and more particularly, to a damper of a torque converter for a vehicle, capable of improving booming at low speeds in a torque converter employing a multi-plate clutch and suppressing generation of abnormal vibration at high speeds.

### Description of Related Art

In general, a torque converter is installed between an engine of a vehicle and a transmission to transmit driving power of the engine to the transmission using a fluid. The torque converter includes an impeller rotated upon receiving driving power from the engine, a turbine rotated by oil discharged from the impeller, and a reactor (or a stator) causing a flow of oil fed back to the impeller to be oriented in a rotation direction of the impeller to increase a torque variation.

When a load acting on an engine is increased, power transmission efficiency may be lowered, and thus, the torque converter has a lock-up clutch (or damper clutch) directly connecting the engine and the transmission. The lock-up clutch is disposed between a front cover connected to the engine and a turbine to allow rotational force from the engine to be directly transmitted to the turbine.

Automatic transmission vehicles generally use a torque converter. However, since the torque converter is a fluidic device involving slip, a torque converter clutch is introduced to improve fuel efficiency and operation coverage of the torque converter clutch has expanded.

In general, engagement of a torque converter clutch in a low engine RPM may improve fuel efficiency but noise, vibration, harshness (NVH) problem such as booming arises in a vehicle. In order to improve the NVH problem due to expansion of the direct connection area, rigidity of a torsion damper spring within a torque converter is generally lowered to reduce rotation variations.

Another scheme of avoiding the NVH problem arising in engagement is torque converter clutch slip control. Compared with a non-direct connection, the torque converter clutch slip control reduces a slip amount of a torque converter o improve fuel efficiency, absorbs rotational vibrations of an engine to solve the NVH problem of a vehicle, and is advantageous in terms of drivability, and as such, the torque converter clutch slip control is generally used.

The torque converter clutch slip control causes frictional heat, so a multi-plate clutch with increased heat capacity is commonly used in a rear wheel transmission, and recently, multi-plate clutches have been increasingly employed in front wheel transmissions significantly restricted in full length.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a damper of a torque converter for a vehicle, capable of supporting disposition, an axial direction, and a longitudinal direction with respect to each component of a torsion damper in a torque converter employing two or more multi-plate friction members and a piston of a separate chamber.

According to various aspects of the present invention, a damper of a torque converter for a vehicle may include a front cover, an impeller rotatably coupled to the front cover, a turbine disposed facing the impeller, a reactor disposed between the impeller and the turbine for changing flow of oil transferred from the turbine toward the impeller, a driving disk assembled to a driving hub connected to the front cover, a driven hub to which a driven disk may be assembled, in which the driven hub may be coupled to a side plate to support a first end of an inside spring disposed in a circumferential direction, a second end of the inside spring may be supported by a retaining plate, the retaining plate supports a first end of an outside spring disposed in a circumferential direction, and a second end of the outside spring may be supported by a driven plate, a turbine shell connected to a turbine hub transferring torque to a transmission, and a driven plate connected to the turbine shell, in which the driven hub may be supported with the turbine hub toward a gap in a longitudinal direction and supported toward the gap in an axial direction from the retaining plate and the turbine hub, and the retaining plate may support the turbine hub toward the gap in the longitudinal direction and may be supported by the turbine hub and the turbine shell toward the gap in the axial direction.

The retaining plate may support the turbine hub toward the gap in a longitudinal direction and may support the driven hub and the turbine shell toward the gap in an axial direction.

The retaining plate may support the turbine hub by a gap in a longitudinal direction and may be supported in a gap by the side plate and the turbine shell in an axial direction.

The side plate connected to the driven hub may supports the turbine shell by a gap in a longitudinal direction, and may support the turbine hub with the retaining plate in a gap in an axial direction.

The driven hub may be coaxially disposed with the turbine hub and may be connected to the side plate by a gap in a longitudinal direction to support and compress the inside spring on a circumference thereof to transfer torque to the retaining plate.

The outside spring and the inside spring my absorb vibrations and impact in a rotational direction, and the turbine shell connected to the driven plate may transfer driving torque to the transmission through the turbine hub.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a semi-cross-sectional view of a torque converter illustrating various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

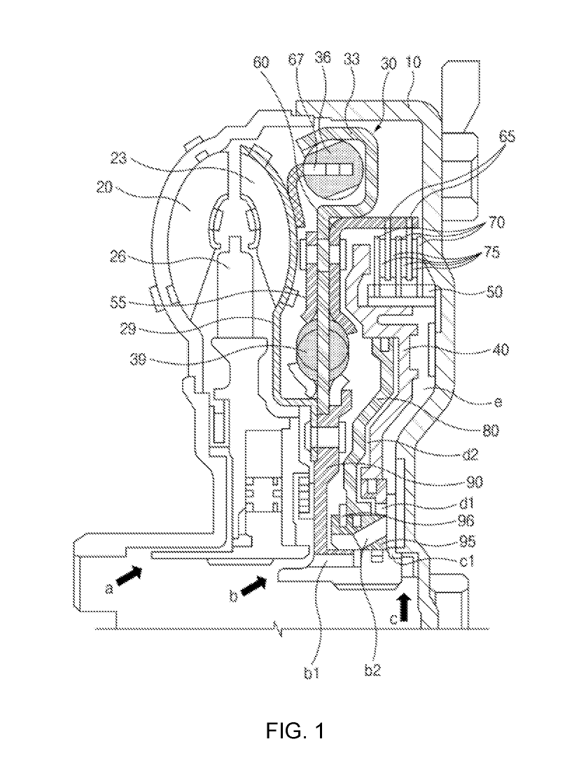

FIG. 1 is a semi-cross-sectional view of a torque converter illustrating various embodiments of the present invention.

A damper of a torque converter for a vehicle may be modified by a person skilled in the art and the various embodiments provide a damper of a torque converter for a vehicle.

Referring to FIG. 1, a damper of a torque converter for a vehicle according to various embodiments of the present invention includes a front cover 10 rotatably connected to a crank shaft of an engine, an impeller 20 rotatably coupled to the front cover 10, a turbine 23 disposed to face the impeller 20, and a reactor (or a stator) 26 disposed between the impeller 20 and the turbine 23 and changing flow of oil transferred from the turbine 23 toward the impeller 20. The reactor 26 transferring oil toward the impeller 20 has the same rotational center as that of the front cover 10. The damper of a torque converter for a vehicle according to various embodiments of the present invention further includes a driving disk 70 assembled to a driving hub 50 connected to the front cover 10, and a driven hub 60 to which a driven disk 65 is assembled. The driven hub 60 is coupled to a side plate 55 to support one end of an inside spring 39 disposed in a circumferential direction, the other end of the inside spring 39 is supported by a retaining plate 33, the retaining plate 33 supports one end of an outside spring 36 disposed in a circumferential direction, and the other end of the outside spring 36 is supported by a driven plate 67. The damper of a torque converter for a vehicle according to various embodiments of the present invention further includes a turbine shell 29 connected to a turbine hub 90 transferring torque to a transmission, and the driven plate 67 connected to the turbine shell 29.

The driven hub 60 is supported in a gap with the turbine hub 90 in a longitudinal direction and supported in an axial direction in a gap from the retaining plate 33 and the turbine hub 90, and the retaining plate 33 is supported in a gap by the turbine hub 90 in a longitudinal direction and supported in a gap by the turbine hub 90 and the turbine shell 29 in an axial direction.

The retaining plate 33 may support the turbine hub 90 towards the gap in a longitudinal direction, and may support the driven hub 60 and the turbine shell 29 towards the gap in an axial direction.

The retaining plate 33 may support the turbine hub 90 towards the gap in a longitudinal direction and may be supported by the side plate 55 and the turbine shell 29 towards the gap in an axial direction.

The side plate 55 connected to the driven hub 60 may be supported by a turbine shell 29 in a gap in a longitudinal direction, and may be supported in a gap by the retaining plate 33 and the turbine hub 90 in an axial direction.

The torque converter of various embodiments of the present invention includes a lock-up clutch as a means for directly connecting an engine and a transmission. The lock-up clutch is disposed between the front cover 10 and the turbine 23.

The lock-up clutch may have a piston 40 having a substantially disk shape and moving in an axial direction. A torsional damper 30 is coupled to the lock-up clutch.

The torsional damper 30 transfers driving force transferred through the lock-up clutch to the turbine 23 to serve to absorb a torsional force acting in a rotation al direction of an axis and dampen vibrations.

The lock-up clutch includes the driving disk 70 and the driven disk 65 disposed between the front cover 10 and the piston 40. Friction members 75 are disposed between the driving disk 70 and the driven disk 65, and one side of the friction members 75 is attached to the driving disk 70 or the driven disk 65.

The driving hub 50 is connected to the front cover 10, and the driving disk 70 assembled to the driving hub 50 and the driven disk 65 assembled to the driven hub 60 are coaxially disposed.

The driving disk 70 may be assembled to the driving hub 50 coupled to the front cover 10 and move in an axial direction. The driven disk 65 may be assembled to the drive hub 60 and move in an axial direction.

Thus, in the look-up clutch, when the piston 40 moves in a direction toward the front cover 10 by oil pressure, the driving disk 70, the driven disk 65, and the friction members 75 are tightly attached between the front cover 10 and the piston 40 to transfer driving torque transferred from the front cover 10 and the driving hub 50 to the driven hub 60.

The torsional damper 30 includes a retaining plate 33, an outside spring 36, an inside spring 39, the side plate 55, and the driven hub 60.

The outside spring 36 and the inside spring 39 disposed in a circumferential direction may absorb vibrations and impact in a rotational direction by elastic force when the lock-up clutch operates.

The driven hub 60 receiving driving torque from the driven disk 65 of the lock-up clutch is connected to the side plate 55 and supports one end of the inside spring 39 disposed in a circumferential direction, and the other end of the inside spring 39 is supported by the retaining plate 33. The inside spring 39 makes a relative movement in a rotational direction by an elastic force thereof between the driven hub 60 connected to the side plate 55 and the retaining plate 33.

The retaining plate 33 supports one end of the outside spring 36 disposed in a circumferential direction, and the other end of the outside spring 36 is supported by the driven plate 67. The outside spring 36 makes a relative movement in a rotational direction by an elastic force thereof between the retaining plate 33 and the driven plate 67.

Driving torque transferred when the lock-up clutch operates is transferred to the retaining plate 33 through the driven hub 60, the side plate 55, and the inside spring 39, and transferred to the driven plate 67 through the outside spring 36. The driven plate 67 is connected to the turbine shell 29, and the turbine shell 29 is connected to the turbine hub 90. The turbine hub 90 may transfer driving torque to the transmission.

The piston 40 is assembled to a piston hub 95 such that it is movable in an axial direction. In order to restrict a movement of the piston 40 in a circumferential direction, a certain number of keys or splines may be installed between the driving hub 50 and the piston 40 or between the piston 40 and the piston hub 95. Since the piston hub 95 or the driving hub 50 is coupled to the front cover 10, the piston 40 rotates together with the front cover 10.

A movement of the piston 40 in an axial direction is restricted by the driving disk 70 and the driven disk 65 on one side and restricted by the cover plate 80 on the other side. The cover plate 80 is assembled by the piston hub 95 and a snap ring 96 or connected to the piston hub 96 by welding.

An operational process of the exemplary embodiment of the present invention will be described. When the lock-up clutch operates, the piston 40 moves toward the front cover 10 by oil pressure between the cover plate 80 and the piston 40. Then, the driving disk 70 and the driven disk 65 are tightly attached to each other and driving torque of the front cover 10 is transferred to the driven disk 65 and the driven hub 60 through the driving hub 50 and the driving disk 70. As the side plate 55 connected to the driven hub 60 compresses the inside spring 39, driving torque is transferred to the retaining plate 33 connected to the other end of the inside spring 39. As the retaining plate 33 compresses the outside spring 36, driving torque is transferred to the driven plate 67 connected to the other end of the outside spring 36.

Here, the outside spring 36 and the inside spring 39 absorb vibrations and impact in a rotational direction. The turbine shell 29 connected to the driven plate 67 transfers driving torque to the transmission through the turbine hub 90.

A flow channel d2 between the cover plate 80 and the piston 40, which causes the piston 40 to move toward the front cover 10 when directly connected, is connected to a flow channel d1 present in the piston hub 95. A flow channel e is provided to cool the friction members 75 on the driving disk 70 and the driven disk 65.

In order to provide appropriate oil pressure to the flow channels d1, d2, and e according to roles of oil pressures a, b, and c provided from the transmission, a plurality of recesses and holes are provided in the piston hub 95. When a lock-up clutch direct connection oil pressure provided from the transmission is c and a clutch cooling flow channel b, the piston hub 95 provides a flow path through the plurality of recesses and holes such that oil pressure c is connected to the flow channels d1 and d2 and oil pressure b is connected to the flow channel e. If the lock-up clutch direct connection oil pressure provided from the transmission is b and the clutch cooling flow channel is c, the piston hub 95 provides a flow path such that the oil pressure b is connected to the flow channels d1 and d2 and the oil pressure c is connected to the flow channel e.

The driven hub 60 is supported by the turbine hub 90 in a gap in a longitudinal direction, and supported by the retaining plate 33 and the turbine hub 90 in a gap in an axial direction. The retaining plate 33 is supported by the turbine hub 90 by a gap in a longitudinal direction and supported by the turbine shell 29 and the turbine hub 90 in a gap in an axial direction. The driven hub 60 coaxially disposed with the turbine hub 90 is connected to the side plate 55 by a gap in a longitudinal direction to support and compress the inside spring 39 on the circumference to transfer torque to the retaining plate 33.

The retaining plate 33 is supported by the turbine hub 90 by a gap in a longitudinal direction and supported in a gap by the driven hub 60 and the turbine shell 29 in an axial direction.

The retaining plate 33 may be supported by the turbine hub 90 by a gap in a longitudinal direction and supported in a gap by the side plate 55 and the turbine shell 29 in an axial direction.

The side plate 55 connected to the driven hub 60 is supported by the turbine shell 29 in a gap in a longitudinal direction, and supported in a gap by the retaining plate 33 and the turbine hub 90 in an axial direction.

Accordingly, the torque converter employing the disposition of the torsional damper 30 with respect to the respective components, a plurality of friction plates, i.e., two or more friction plates, having the support structure in the axial direction and the longitudinal direction, and the piston of a separate chamber is implemented.

As described above, the damper of a torque converter for a vehicle has one or more advantages as follows.

According to various embodiments of the present invention, in the torque converter employing a plurality of multi-plate friction members (two or more friction members) and the piston of a separate chamber, the disposition of the torsional damper with respect to respective components and an axial direction and a longitudinal direction are supported.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A damper of a torque converter for a vehicle, the damper comprising:
a front cover;
an impeller rotatably coupled to the front cover;
a turbine disposed facing the impeller;
a reactor disposed between the impeller and the turbine for changing flow of oil transferred from the turbine toward the impeller;
a driving disk assembled to a driving hub connected to the front cover;
a driven hub to which a driven disk is assembled, wherein
the driven hub is coupled to a side plate to support a first end of an inside spring disposed in a circumferential direction thereof;
a second end of the inside spring is supported by a retaining plate;
the retaining plate supports a first end of an outside spring disposed in a circumferential direction thereof; and
a second end of the outside spring is supported by a driven plate;
a turbine shell connected to a turbine hub transferring torque to a transmission; and
a driven plate connected to the turbine shell, wherein
the driven hub is supported with the turbine hub toward a gap in a longitudinal direction and supported toward the gap in an axial direction from the retaining plate and the turbine hub; and
the retaining plate supports the turbine hub toward the gap in a longitudinal direction and is supported by the turbine hub and the turbine shell toward the gap in the axial direction.

2. The damper according to claim 1, wherein the retaining plate supports the turbine hub toward the gap in a longitudinal direction and supports the driven hub and the turbine shell toward the gap in an axial direction.

3. The damper according to claim 1, wherein the retaining plate supports the turbine hub by a gap in a longitudinal direction and is supported in a gap by the side plate and the turbine shell in an axial direction.

4. The damper according to claim 1, wherein the side plate connected to the driven hub supports the turbine shell by a gap in a longitudinal direction, and supports the turbine hub with the retaining plate in a gap in an axial direction.

5. The damper according to claim 1, wherein the driven hub is coaxially disposed with the turbine hub and is connected to the side plate by a gap in a longitudinal direction to support and compress the inside spring on a circumference thereof to transfer torque to the retaining plate.

6. The damper according to claim 1, wherein the outside spring and the inside spring absorb vibrations and impact in a rotational direction, and the turbine shell connected to the driven plate transfers driving torque to the transmission through the turbine hub.
